(19) United States
(12) Patent Application Publication
(10) Pub. No.: US 2008/0037064 A1
(43) Pub. Date: Feb. 14, 2008

(54) Method and system for establishing customer service level requirements for web based production print jobs

(75) Inventors: Frank M. Goetz, Fairport, NY (US); George L. Eldridge, Long Beach, CA (US)

Correspondence Address: Clifford P. Kelly;Alix, Yale & Ristas, LLP, Suite 1400, 750 Main Street, Hartford, CT, 06106-5029, US

(73) Assignee: Xerox Corporation

(21) Appl. No.: 11/500,866

(22) Filed: Aug. 8, 2006

(51) Int. Cl. G06K 15/00

(52) U.S. Cl. 358/1.16

(57) ABSTRACT

A printer system facilitating establishment of customer service level requirements includes at least one printing device, a system computer in communications with the printing device, and at least one user computer in communications with the system computer. A database stored in the system computer includes a decision table having a rules set comprising at least one of customer cost rules, shop schedule rules, resource availability rules, and capacity rules. A method of establishing customer service level requirements for web based production print jobs includes uploading at least one digital file defining print job content from the user computer to the printer system computer via the Internet. At least one specification variable, selected from the number of copies to be printed, the print job cost, the print job quality, or the delivery date is selected. Print job production data correlating to the specification variable is computed and displayed and the print job is printed if the print job production data is acceptable.

### BACKGROUND

This disclosure relates generally to web based production print jobs. More particularly, the present disclosure relates to an apparatus and method of establishing customer service level requirements for web based production print jobs.

As consumers have become more familiar and adept at conducting business over the Internet, the number of production print jobs submitted via the web has increased. The growth in such submissions has been facilitated by the development of print web store front utilities that are more user friendly. However, the utility of web based production print jobs is constrained by limitations within the methodology of conventional print web store front utilities. For example, conventional utilities either do not allow deviations or exceptions to the production model utilized by the utility, or make it difficult to effect such deviations or exceptions. Further, conventional utilities do not provide feedback on how a change in any one of the production variables will affect the other production variables. Accordingly, submission of production print jobs in person provides greater flexibility and utility than submission via the Internet.

### SUMMARY

There is provided a printer system that facilitates the establishment of customer service level requirements. The system comprises at least one printing device, a system computer in communications with the at least one printing device, and at least one user computer in communications with the system computer. The system computer includes an operating system stored on a hard drive and a database stored on the hard drive. The database includes a decision table having a rules set comprising at least one of customer cost rules, shop schedule rules, resource availability rules, and capacity rules.

The database also includes a production model comprising formatted data including customer cost data, shop schedule data, shop resource data and shop capacity data. The shop schedule data, shop resource data and shop capacity data includes data measured at the print shop utilizing the printer system.

The database also includes a plurality of templates, where each of the templates defines a format for a print job.

There is also provided a method of establishing customer service level requirements for web based production print jobs. The method comprises logging a user computer into the operating system of a production print shop printer system computer via the Internet. At least one digital file defining print job content is uploaded from the user computer to the printer system computer. At least one specification variable, selected from the number of copies to be printed, the print job cost, the print job quality, or the delivery date is selected. Print job production data correlating to the at least one specification variable is computed and displayed. The print job is then printed if the print job production data is acceptable.

Before the specification variable is selected, the user is directed to select a template for the printed work from a menu of templates. When the print job production data is displayed, print job production data associated with the template selected by the user is displayed.

The method further comprises prompting the user to submit an order for the print job to the printer system computer after the print job production data is displayed. If the user submits the order, a firm quote for the print job is generated and transmitted to the user computer. The user computer is then queried whether the quoted print job is authorized. If the quoted print job is authorized, the print job is printed. Otherwise, the user computer is logged-out from the printer system computer operating system.

If the user does not submit the order, the user may select one of the specification variables and reset the selected specification variable with the user computer. Print job production data correlating to the selected specification variable is then computed and displayed. The user is then prompted to submit an order for the print job to the printer system computer.

Computing print job production data may comprise computing multiple production options, with each production option comprising a set of print job production data correlating with the reset value of the selected production variable. When the print job production data is displayed, all of the production options are displayed.

After the production options are displayed, the user is prompted to select one of the production options. If the user selects one of the production options, the user is then prompted to submit the order. If the user does not select one of the production options, the user computer is logged-out from the printer system computer operating system or the user selects another one of the specification variables and resets the selected specification variable with the user computer.

### BRIEF DESCRIPTION OF THE DRAWINGS

The present disclosure may be better understood and its numerous objects and advantages will become apparent to those skilled in the art by reference to the accompanying drawings in which:

FIG. 1 is a schematic diagram of a printer system utilizing a method of establishing customer service level requirements, showing the printer system connected to user computer systems via the Internet;

FIG. 2 is a flow diagram for a method of establishing customer service level requirements for web based production print jobs;

FIG. 3 is an example of a summary field display; and

FIG. 4 is an example of an option field display.

### DETAILED DESCRIPTION

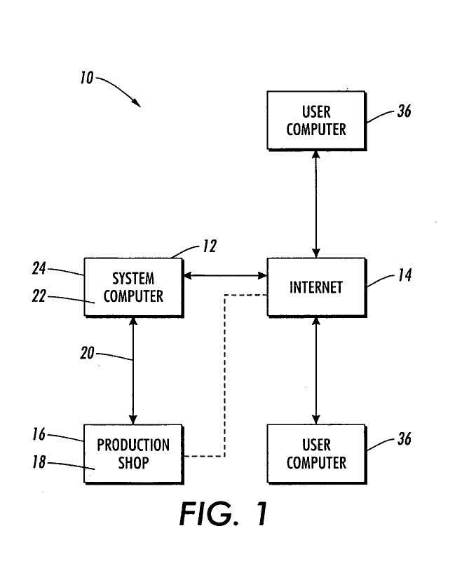

With reference to the drawings wherein like numerals represent like parts throughout the several figures, a printer system utilizing a method of establishing customer service level requirements in accordance with the present disclosure is generally designated by the numeral 10. The printer system 10 (FIG. 1) comprises a system computer 12, including a keyboard, a display and a mouse (none of which are shown), and is connected to the Internet 14. In addition, the printer system 10 includes such apparatus 16 as is commonly found in a production print shop 18, for example black and white printers, color printers, and binding devices. The system computer 12 may be located within the print shop 18. Alternatively, the system computer 12 may be at a location remote from the print shop 18 and connected to a print shop computer via a LAN 20 or the Internet.

The system computer 12 includes one or more hard drives for storing an operating system 22, described in detail below. A database 24 (FIG. 5) or a set of related databases are also stored on the hard drive(s), a single database will be described to facilitate discussion.

The database 24 includes a QCD decision control table comprising a set of rules 26 encompassing the policies of the print shop with regard to customer cost, shop schedule, resource availability and capacity. The sets of rules 26 optimize one of three parameters quality, cost, or delivery, for any set of variables associated with a print job. The priority of the rule sets can be modified by the customer profile, the shop schedule, and by the user through the user computer. For example, the user may instruct the operating system to optimize cost at the expense of quality and/or delivery.

The database 24 also includes a production QCD model comprising formatted data corresponding to customer cost 28, shop schedule information 30, shop resources 32 and shop capacity 34. The production QCD model provides a common representation for the information that QCD decision control utilizes to determine the optimum value of the selected parameter. Where possible, actual production shop information is utilized in the production QCD model. For example, information regarding the equipment installed in the print shop, the personnel resources available to the print shop 18, or the raw materials (paper, etc.) available at the print shop 18 is used if available.

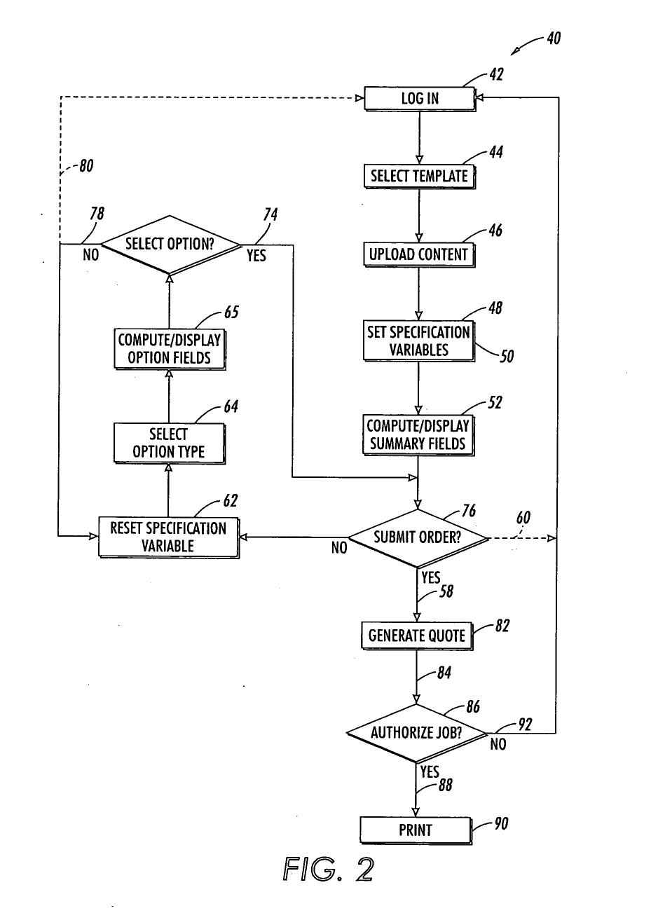

The operating system 22 stored in the system computer 12 embodies a method 40 of establishing customer service level requirements for web based production print jobs, that is print jobs submitted to a production print shop via the Internet. As shown in FIG. 2, a user desiring to produce a printed work from content to be provided by the user first logs-in 42 to the printer system 10 from their user computer 36 via the Internet 14. “Content” is hereby defined to include any digital file, for example text, figures and photographs, that may be used to produce printed mater. The user may log-in 42 on a one-time basis or into an established account. If the user does not have an account, they may register a new account in a manner known in the art and then log-in to the new account.

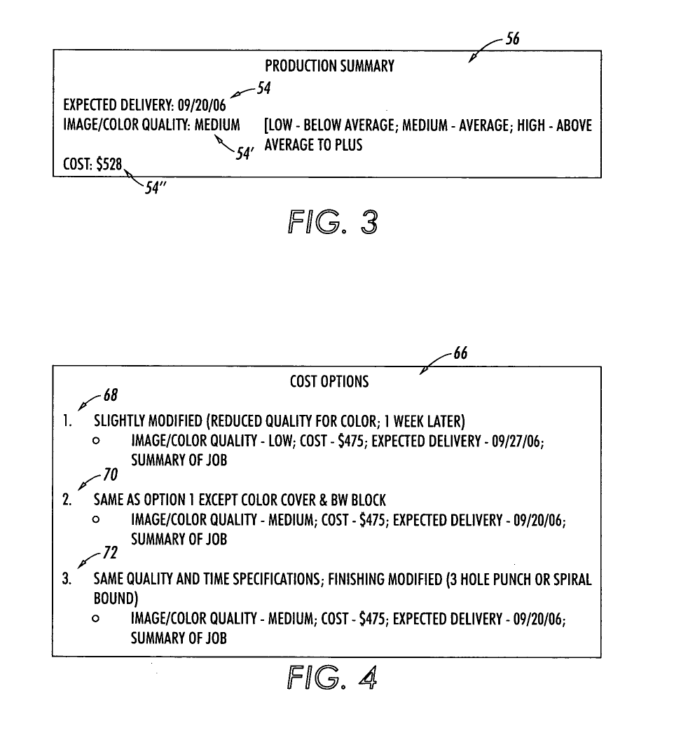

After logging-in 42, the user is directed to select 44 a template for the format of the printed work from a menu 38 of available templates. The user then uploads 46 the digital files comprising the user supplied content to the printer system 10 and inputs 48 the number of prints that are to be produced, setting 50 the applicable specification variable. The system computer 12 computes and displays 52 summary fields 54, 54′, 54″ of print job production data corresponding to the template selected by the user. FIG. 3 illustrates a typical summary field display 56, displaying the following information:

| Summary Field Name | Computed Field Data |
|---|---|
| Delivery Date | date |
| Image/Color Quality | low, medium, or high |
| Cost | dollar cost to user |

If the data displayed in the summary field display 56 is acceptable, the user submits 58 the job request to the print shop 18 for confirmation. If any of the data displayed in the summary field display 56 is unacceptable, the user may either exit 60, returning the operating system to standby, or reset 62 one of the specification variables. If for example the user believes that the $528.00 cost shown in FIG. 3 is too high, the user would select 64 the cost option by inputting 62 a lower cost into the cost data field 54″, prompting the system computer 12 to provide 65 production options based upon the cost inputted 62 by the user. It should be appreciated that the user could have alternatively selected 64 either the quality option of the delivery option by inputting a different value into the quality field 54′ or the delivery field 54, respectively.

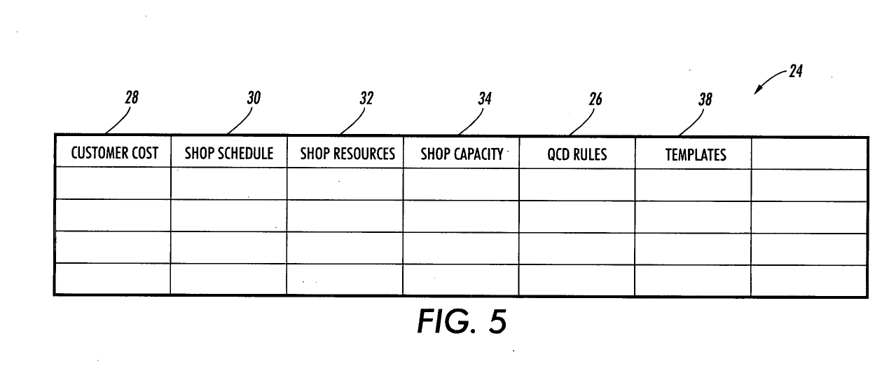

Each production option represents a set of print job production data that correlates with the value inputted the selected production variable. FIG. 4 illustrates a typical option field display 66, for a user input of $475.00 in the cost data field 54″. In this example, the operating system 22 provides three options for producing the print job at a price of $475.00. In the first option 68, the quality of the image/color has been reduced from medium to low and the delivery is delayed by one week. In the second option 70, the quality and delivery date remain the same but only the cover will be printed in color. In the third option 72, the quality and delivery date remain the same but the product will be finished less expensively, requiring either a three hole punch finish or a spiral bound finish.

If one of the options 68, 70, 72 is acceptable, the user selects 74 the acceptable option and is queried 76 whether the order should be submitted to the print shop 18 for confirmation. If none of the options is acceptable 78, the user may either reset 62 another specification variable, for example the delivery date or the quality, or may exit 80 the printer system 10.

The print shop 18 generates 82 a firm quote as a means of confirming that the production shop information utilized by the operating system 22 is complete and up-to-date and that the cost data provided to the user is accurate. A “firm quote” is hereby defined to be a quote that provides production and cost information to which the print shop is willing to be legally bound. After the quote is presented 84, the operating system 22 queries 86 the user to determine whether the user will authorize the print job under the terms provided in the quote. If the user authorizes 88 the print job, it is submitted to the print job queue for printing 90. If the user does not authorize the print job, the user exits 92 the printer system 10.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A printer system facilitating the establishment of customer service level requirements comprises:
at least one printing device;
a system computer in communications with the at least one printing device, the system computer including
at least one hard drive,
an operating system stored on the hard drive, and
a database stored on the hard drive, the database including a decision table having a rules set comprising at least one of customer cost rules, shop schedule rules, resource availability rules, and capacity rules; and
at least one user computer in communications with the system computer.

2. The printer system of claim 1 wherein the database also includes a production model comprising formatted data comprising customer cost data, shop schedule data, shop resource data and shop capacity data.

3. The printer system of claim 2 wherein the at least one printing device is disposed in a print shop and the shop schedule data, shop resource data and shop capacity data includes data measured at the print shop.

4. The printer system of claim 1 wherein the database also includes a plurality of templates, each of the templates defining a format for a print job.

5. A method of establishing customer service level requirements for web based production print jobs, the method comprising:
logging a user computer into an operating system of a printer system computer of a production print shop, over the Internet;
uploading at least one digital file defining print job content from the user computer to the printer system computer;
setting at least one specification variable selected from the number of copies to be printed, the print job cost, the print job quality, or the delivery date;
computing print job production data correlating to the at least one specification variable;
displaying the print job production data; and
printing the print job if the print job production data is acceptable.

6. The method of claim 5 wherein before the at least one specification variable is selected, the user is directed to select a template for the printed work from a menu of templates.

7. The method of claim 6 wherein displaying the print job production data comprises displaying print job production data associated with the template selected by the user.

8. The method of claim 5 further comprising prompting the user to submit an order for the print job to the printer system computer after the print job production data is displayed.

9. The method of claim 8 further comprising:
generating and transmitting a firm quote for the print job to the user computer, if the user submits the order;
querying the user computer whether the quoted print job is authorized; and
printing the print job if the quoted print job is authorized; or
logging-out the user computer from the printer system computer operating system if the quoted print job is not authorized.

10. The method of claim 8 further comprising:
selecting one of the specification variables with the user computer, if the user does not submit the order;
resetting the selected specification variable with the user computer;
computing print job production data correlating to the selected specification variable;
displaying the print job production data; and
prompting the user to submit an order for the print job to the printer system computer after the print job production data is displayed.

11. The method of claim 10 wherein computing print job production data comprises computing a plurality of production options, each production option comprising a set of print job production data correlating with the reset value of the selected production variable.

12. The method of claim 11 wherein displaying the print job production data comprises displaying all of the production options.

13. The method of claim 12 wherein after the production options are displayed the user is prompted to select one of the production options.

14. The method of claim 13 wherein if the user selects one of the production options, the user is prompted to submit the order.

15. The method of claim 14 wherein if the user does not select one of the production options;
the user computer is logged-out from the printer system computer operating system; or
the user selects another one of the specification variables with the user computer; and
the user resets the selected specification variable with the user computer.

16. A method of establishing customer service level requirements for web based production print jobs, the method comprising:
logging a user computer into an operating system of a printer system computer of a production print shop, over the Internet;
selecting a template for the printed work from a menu of templates;
uploading at least one digital file defining print job content from the user computer to the printer system computer;
setting at least one specification variable selected from the number of copies to be printed, the print job cost, the print job quality, or the delivery date;
computing print job production data correlating to the at least one specification variable;
prompting the user to submit an order for the print job to the printer system computer;
selecting one of the specification variables with the user computer, if the user does not submit the order;
resetting the selected specification variable with the user computer;
computing print job production data correlating to the selected specification variable;
displaying the print job production data;
prompting the user to submit an order for the print job to the printer system computer after the print job production data is displayed;
generating and transmitting a firm quote for the print job to the user computer, if the user submits the order;
querying the user computer whether the quoted print job is authorized; and
printing the print job is the quoted print job is authorized; or
logging-out the user computer from the printer system computer operating system if the quoted print job is not authorized;
displaying the print job production data; and
printing the print job if the print job production data is acceptable.

17. The method of claim 16 wherein displaying the print job production data comprises displaying print job production data associated with the template selected by the user.

18. The method of claim 16 wherein computing print job production data comprises computing a plurality of production options, each production option comprising a set of print job production data correlating with the reset value of the selected production variable.

19. The method of claim 18 wherein displaying the print job production data comprises displaying all of the production options.

20. The method of claim 19 wherein after the production options are displayed the user is prompted to select one of the production options.
